(19) United States
(12) Patent Application Publication
(10) Pub. No.: US 2022/0375015 A1
(43) Pub. Date: Nov. 24, 2022

(54) SYSTEMS AND METHODS FOR EXPERIENTIAL SKILL DEVELOPMENT

(71) Applicant: Pearson Education, Inc., Bloomington, MN (US)

(72) Inventors: Zoe BOTTERIL, Saffron (GB); Sara BAKKEN, Webster, TX (US); Neha SHARMA, London (GB); Richard STAGG, London (GB); Kobi LEE, London (GB); Shiban SAYED, London (GB); Vanita JAIN, Pleasanton, CA (US); Rebecca YOSHOR, New York, NY (US); Elizabeth GRAHAM-MEREDITH, Boston, MA (US)

(21) Appl. No.: 17/769,993

(22) PCT Filed: Nov. 5, 2020
(86) PCT No.: PCT/US2020/059098

§ 371 Date: Apr. 18, 2022

Related U.S. Application Data
(60) Provisional application No. 62/931,028, filed on Nov. 5, 2019.

(51) Int. Cl. G06Q 50/20; G09B 7/02

(52) U.S. Cl. CPC G06Q 50/20; G09B 7/02

(57) ABSTRACT

Systems and methods of the present invention provide for identifying the skills of a candidate, generating and delivering one or more courses for skill development to the candidate, and/or providing certification or other credentials for skills obtained by the candidate via the courses. Identifying the skills may include a server comparing a set of initial skills to a set of requisite skills to identify a set of untrained skills. Generating and delivering courses may include generating a skill path based on the set of untrained skills and delivering course content associated with the untrained skills. Providing certification may include issuing a credential to the user upon determining that the user has successfully completed a course and sending notifications to third party servers and/or a user device indicating completion of the course.

### CROSS-REFERENCE TO RELATED APPLICATION

This application claims the benefit of priority from Provisional Application No. 62/931,028, filed under the same title on Nov. 5, 2019, the entire contents of which is incorporated herein by reference.

### FIELD OF THE INVENTION

This disclosure relates to the field of systems and methods configured to identify the skills of a candidate, generate and deliver one or more courses for skill development to the candidate, and/or provide certification or other credentials for skills obtained by the candidate via the courses.

### BACKGROUND

A computer network or data network is a telecommunications network which allows computers to exchange data. In computer networks, networked computing devices exchange data with each other along network links (data connections). The connections between nodes are established using either cable media or wireless media.

Network computer devices that originate, route and terminate the data are called network nodes. Nodes can include hosts such as personal computers, phones, servers as well as networking hardware. Two such devices can be said to be networked together when one device is able to exchange information with the other device, whether or not they have a direct connection to each other.

Computer networks differ in the transmission media used to carry their signals, the communications protocols to organize network traffic, the network's size, topology and organizational intent. In most cases, communications protocols are layered on other more specific or more general communications protocols, except for the physical layer that directly deals with the transmission media.

### BRIEF DESCRIPTION OF THE DRAWINGS

FIG. 1 illustrates a system level block diagram showing data stores, data centers, servers, and clients of a distributed computing environment, in accordance with various embodiments.

FIG. 2 illustrates a system level block diagram showing physical and logical components of a special-purpose computer device within a distributed computing environment, in accordance with various embodiments.

FIG. 3A illustrates a system by which course content can be recommended to and delivered to users, which may be selected to meet the goals of the users, in accordance with various embodiments.

FIG. 3B illustrates various data stores that may be included in data store servers of FIG. 3A, in accordance with various embodiments.

FIG. 4 illustrates a process flow for a method of recommending and delivering course content to a user based on a skill path that has been defined for the user, in accordance with an embodiment.

FIG. 5A shows an illustrative course description that may be displayed to a user to enable the user to enroll in a course in project management, in accordance with an embodiment.

FIG. 5B shows an illustrative course summary page that defines a challenge addressed during the project management course, and shows group members participating in the project management course, in accordance with an embodiment.

FIG. 5C shows an illustrative activity scheduling page that may be included as part of the project management course, in accordance with an embodiment.

FIG. 5D shows an illustrative lesson page in a section of a negotiation course, in accordance with an embodiment.

FIG. 5E shows an illustrative reflection page in a section of a negotiation course, in accordance with an embodiment.

FIG. 6 shows an illustrative mentee dashboard page, in accordance with an embodiment.

FIG. 7 shows an illustrative mentee dashboard page, in accordance with an embodiment.

FIG. 8 shows an illustrative mentor dashboard page, in accordance with an embodiment.

FIG. 9 shows an illustrative mentee dashboard page, in accordance with an embodiment.

FIG. 10 shows an illustrative mentor dashboard page, in accordance with an embodiment.

FIG. 11 shows an illustrative mentee dashboard page, in accordance with an embodiment.

FIG. 12 shows an illustrative flow diagram of interactions between the mentor and the mentee, in accordance with an embodiment.

### DETAILED DESCRIPTION

The present inventions will now be discussed in detail with regard to the attached drawing figures that were briefly described above. In the following description, numerous specific details are set forth illustrating the Applicant's best mode for practicing the invention and enabling one of ordinary skill in the art to make and use the invention. It will be obvious, however, to one skilled in the art that the present invention may be practiced without many of these specific details. In other instances, well-known machines, structures, and method steps have not been described in particular detail in order to avoid unnecessarily obscuring the present invention. Unless otherwise indicated, like parts and method steps are referred to with like reference numerals.

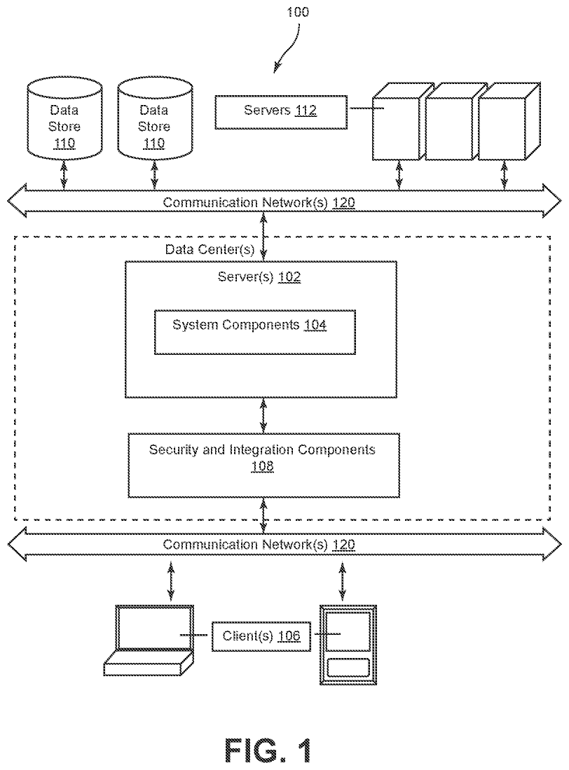

FIG. 1 illustrates a non-limiting example distributed computing environment 100, which includes one or more computer server computing devices 102, one or more client computing devices 106, and other components that may implement certain embodiments and features described herein. Other devices, such as specialized sensor devices, etc., may interact with client 106 and/or server 102. The server 102, client 106, or any other devices may be configured to implement a client-server model or any other distributed computing architecture.

Server 102, client 106, and any other disclosed devices may be communicatively coupled via one or more communication networks 120. Communication network 120 may be any type of network known in the art supporting data communications. As non-limiting examples, network 120 may be a local area network (LAN; e.g., Ethernet, Token-Ring, etc.), a wide-area network (e.g., the Internet), an infrared or wireless network, a public switched telephone networks (PSTNs), a virtual network, etc. Network 120 may use any available protocols, such as (e.g., transmission control protocol/Internet protocol (TCP/IP), systems network architecture (SNA), Internet packet exchange (IPX), Secure Sockets Layer (SSL), Transport Layer Security (TLS), Hypertext Transfer Protocol (HTTP), Secure Hypertext Transfer Protocol (HTTPS), Institute of Electrical and Electronics (IEEE) 802.11 protocol suite or other wireless protocols, and the like.

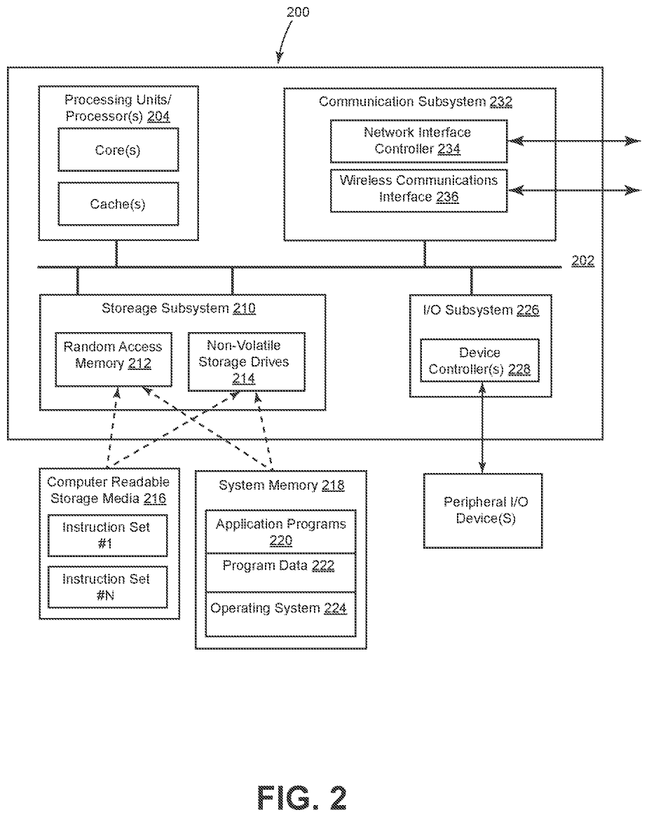

The embodiments shown in FIGS. 1-2 are thus one example of a distributed computing system and is not intended to be limiting. The subsystems and components within the server 102 and client devices 106 may be implemented in hardware, firmware, software, or combinations thereof. Various different subsystems and/or components 104 may be implemented on server 102. Users operating the client devices 106 may initiate one or more client applications to use services provided by these subsystems and components. Various different system configurations are possible in different distributed computing systems 100 and content distribution networks. Server 102 may be configured to run one or more server software applications or services, for example, web-based or cloud-based services, to support content distribution and interaction with client devices 106. Users operating client devices 106 may in turn utilize one or more client applications (e.g., virtual client applications) to interact with server 102 to utilize the services provided by these components. Client devices 106 may be configured to receive and execute client applications over one or more networks 120. Such client applications may be web browser based applications and/or standalone software applications, such as mobile device applications. Client devices 106 may receive client applications from server 102 or from other application providers (e.g., public or private application stores).

As shown in FIG. 1, various security and integration components 108 may be used to manage communications over network 120 (e.g., a file-based integration scheme or a service-based integration scheme). Security and integration components 108 may implement various security features for data transmission and storage, such as authenticating users or restricting access to unknown or unauthorized users,

As non-limiting examples, these security components 108 may comprise dedicated hardware, specialized networking components, and/or software (e.g., web servers, authentication servers, firewalls, routers, gateways, load balancers, etc.) within one or more data centers in one or more physical location and/or operated by one or more entities, and/or may be operated within a cloud infrastructure.

In various implementations, security and integration components 108 may transmit data between the various devices in the content distribution network 100. Security and integration components 108 also may use secure data transmission protocols and/or encryption (e.g., File Transfer Protocol (FTP), Secure File Transfer Protocol (SFTP), and/or Pretty Good Privacy (PGP) encryption) for data transfers, etc.).

In some embodiments, the security and integration components 108 may implement one or more web services (e.g., cross-domain and/or cross-platform web services) within the content distribution network 100, and may be developed for enterprise use in accordance with various web service standards (e.g., the Web Service Interoperability (WS-I) guidelines). For example, some web services may provide secure connections, authentication, and/or confidentiality throughout the network using technologies such as SSL, TLS, HTTP, HTTPS, WS-Security standard (providing secure SOAP messages using XML encryption), etc. In other examples, the security and integration components 108 may include specialized hardware, network appliances, and the like (e.g., hardware-accelerated SSL and HTTPS), possibly installed and configured between servers 102 and other network components, for providing secure web services, thereby allowing any external devices to communicate directly with the specialized hardware, network appliances, etc.

Computing environment 100 also may include one or more data stores 110, possibly including and/or residing on one or more back-end servers 112, operating in one or more data centers in one or more physical locations, and communicating with one or more other devices within one or more networks 120. In some cases, one or more data stores 110 may reside on a non-transitory storage medium within the server 102. In certain embodiments, data stores 110 and back-end servers 112 may reside in a storage-area network (SAN). Access to the data stores may be limited or denied based on the processes, user credentials, and/or devices attempting to interact with the data store.

With reference now to FIG. 2, a block diagram of an illustrative computer system is shown. The system 200 may correspond to any of the computing devices or servers of the network 100, or any other computing devices described herein. In this example, computer system 200 includes processing units 204 that communicate with a number of peripheral subsystems via a bus subsystem 202. These peripheral subsystems include, for example, a storage subsystem 210, an I/O subsystem 226, and a communications subsystem 232.

One or more processing units 204 may be implemented as one or more integrated circuits (e.g., a conventional micro-processor or microcontroller), and controls the operation of computer system 200. These processors may include single core and/or multicore (e.g., quad core, hexa-core, octo-core, ten-core, etc.) processors and processor caches. These processors 204 may execute a variety of resident software processes embodied in program code, and may maintain multiple concurrently executing programs or processes. Processor(s) 204 may also include one or more specialized processors, (e.g., digital signal processors (DSPs), outboard, graphics application-specific, and/or other processors).

Bus subsystem 202 provides a mechanism for intended communication between the various components and subsystems of computer system 200. Although bus subsystem 202 is shown schematically as a single bus, alternative embodiments of the bus subsystem may utilize multiple buses. Bus subsystem 202 may include a memory bus, memory controller, peripheral bus, and/or local bus using any of a variety of bus architectures (e.g. Industry Standard Architecture (ISA), Micro Channel Architecture (MCA), Enhanced ISA (EISA), Video Electronics Standards Association (VESA), and/or Peripheral Component Interconnect (PCI) bus, possibly implemented as a Mezzanine bus manufactured to the IEEE P1386.1 standard).

I/O subsystem 226 may include device controllers 228 for one or more user interface input devices and/or user interface output devices, possibly integrated with the computer system 200 (e.g., integrated audio/video systems, and/or touchscreen displays), or may be separate peripheral devices which are attachable/detachable from the computer system 200. Input may include keyboard or mouse input, audio input (e.g., spoken commands), motion sensing, gesture recognition (e.g., eye gestures), etc.

As non-limiting examples, input devices may include a keyboard, pointing devices (e.g., mouse, trackball, and associated input), touchpads, touch screens, scroll wheels, click wheels, dials, buttons, switches, keypad, audio input devices, voice command recognition systems, microphones, three dimensional (3D) mice, joysticks, pointing sticks, gamepads, graphic tablets, speakers, digital cameras, digital camcorders, portable media players, webcams, image scanners, fingerprint scanners, barcode readers, 3D scanners, 3D printers, laser rangefinders, eye gaze tracking devices, medical imaging input devices, MIDI keyboards, digital musical instruments, and the like.

In general, use of the term “output device” is intended to include all possible types of devices and mechanisms for outputting information from computer system 200 to a user or other computer. For example, output devices may include one or more display subsystems and/or display devices that visually convey text, graphics and audio/video information (e.g., cathode ray tube (CRT) displays, flat-panel devices, liquid crystal display (LCD) or plasma display devices, projection devices, touch screens, etc.), and/or non-visual displays such as audio output devices, etc. As non-limiting examples, output devices may include, indicator lights, monitors, printers, speakers, headphones, automotive navigation systems, plotters, voice output devices, modems, etc.

Computer system 200 may comprise one or more storage subsystems 210, comprising hardware and software components used for storing data and program instructions, such as system memory 218 and computer-readable storage media 216.

System memory 218 and/or computer-readable storage media 216 may store program instructions that are loadable and executable on processor(s) 204. For example, system memory 218 may load and execute an operating system 224, program data 222, server applications, client applications 220, Internet browsers, mid-tier applications, etc.

System memory 218 may further store data generated during execution of these instructions. System memory 218 may be stored in volatile memory (e.g., random access memory (RAM) 212, including static random access memory (SRAM) or dynamic random access memory (DRAM)). RAM 212 may contain data and/or program modules that are immediately accessible to and/or operated and executed by processing units 204.

System memory 218 may also be stored in non-volatile storage drives 214 (e.g., read-only memory (ROM), flash memory, etc.) For example, a basic input/output system (BIOS), containing the basic routines that help to transfer information between elements within computer system 200 (e.g., during start-up) may typically be stored in the non-volatile storage drives 214.

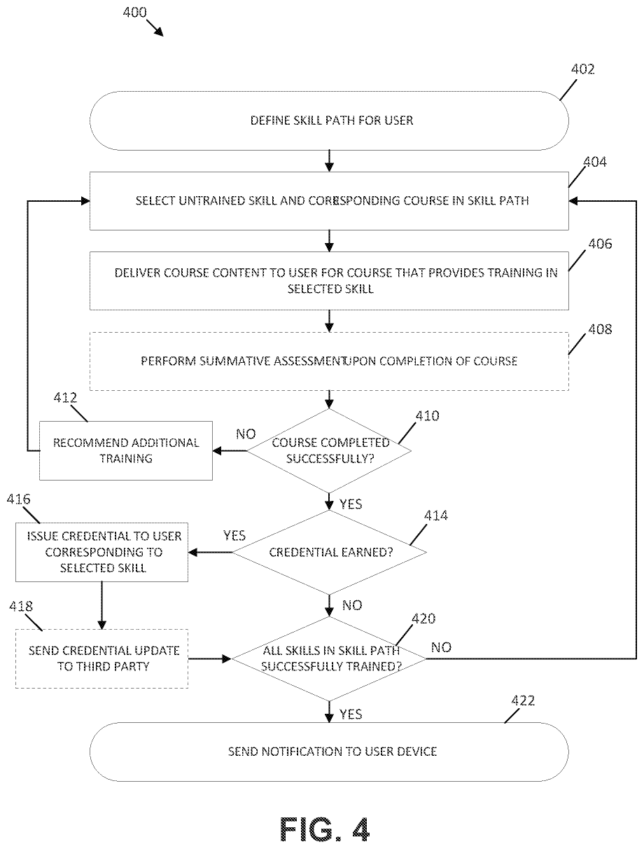

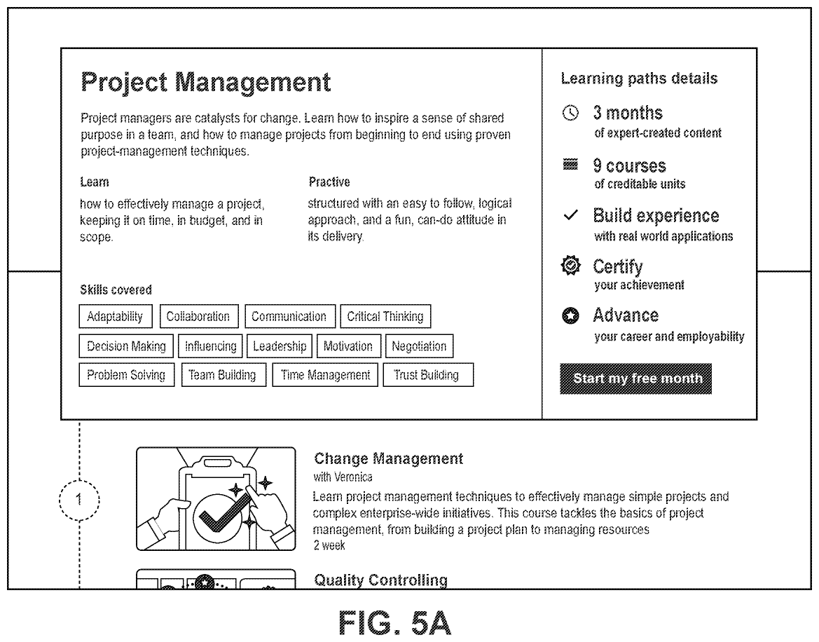

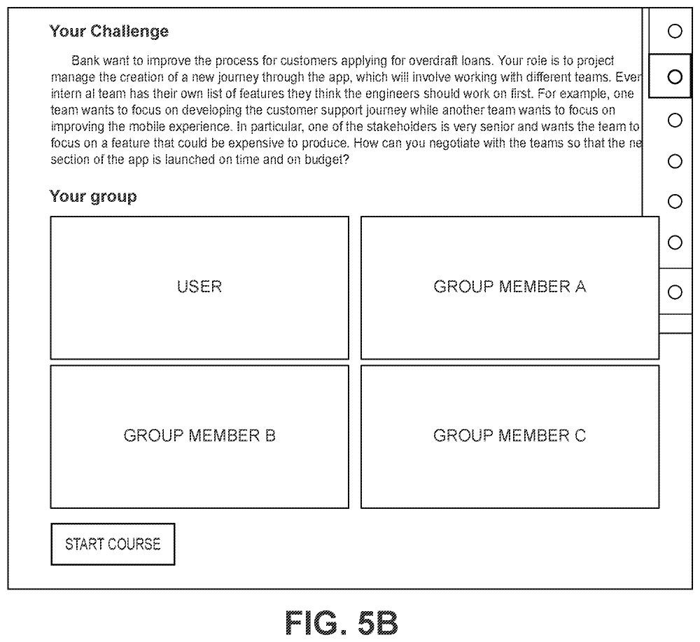

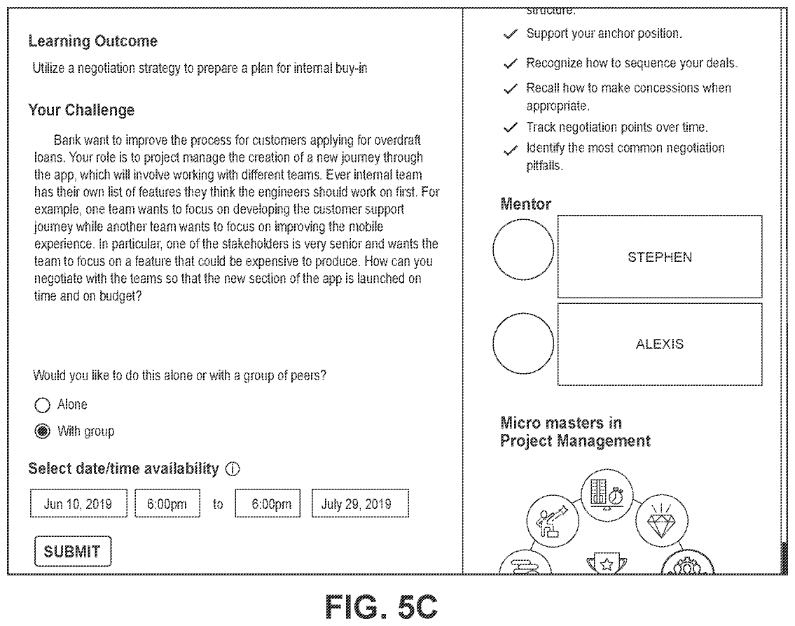

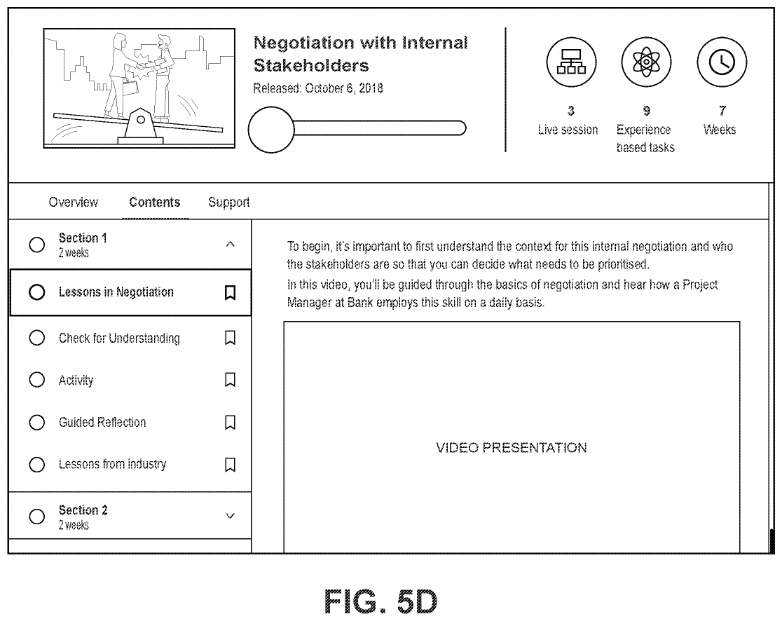

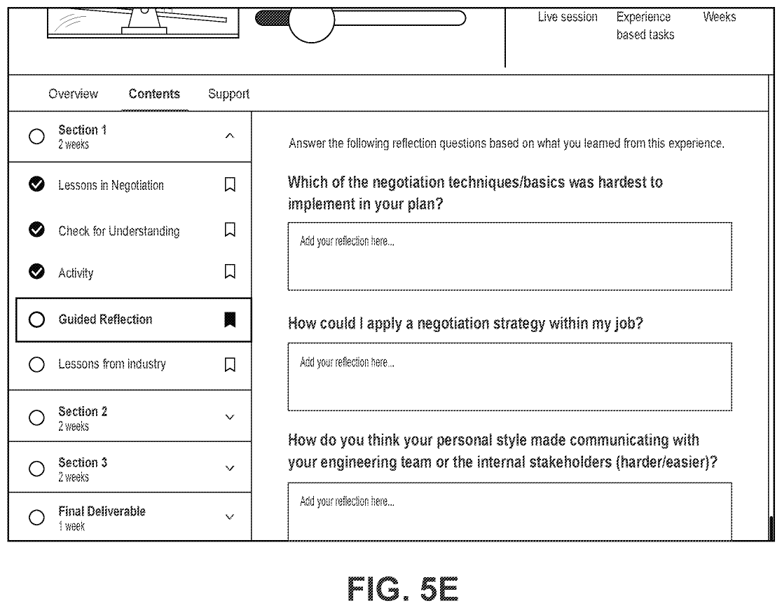

Storage subsystem 210 also may include one or more tangible computer-readable storage media 216 for storing the basic programming and data constructs that provide the functionality of some embodiments. For example, storage subsystem 210 may include software, programs, code modules, instructions, etc., that may be executed by a processor 204, in order to provide the functionality described herein. Data generated from the executed software, programs, code, modules, or instructions may be stored within a data storage repository within storage subsystem 210. For example, the storage subsystem 210 may include any or all source code, object code, executable code, databases, algorithms, methods, processes, user experience (UX) design elements, application programming interfaces, and the like used in the execution of tasks by the system 200 (e.g., execution of method 400 of FIG. 4 or generation of UI screens of FIGS. 5A-5E).

Storage subsystem 210 may also include a computer-readable storage media reader connected to computer-readable storage media 216. Computer-readable storage media 216 may contain program code, or portions of program code. Together and, optionally, in combination with system memory 218, computer-readable storage media 216 may comprehensively represent remote, local, fixed, and/or removable storage devices plus storage media for temporarily and/or more permanently containing, storing, transmitting, and retrieving computer-readable information.

Computer-readable storage media 216 may include any appropriate media known or used in the art, including storage media and communication media, such as but not limited to, volatile and non-volatile, removable and non-removable media implemented in any method or technology for storage and/or transmission of information. This can include tangible computer-readable storage media such as RAM, ROM, electronically erasable programmable ROM (EEPROM), flash memory or other memory technology, CD-ROM, digital versatile disk (DVD), or other optical storage, magnetic cassettes, magnetic tape, magnetic disk storage or other magnetic storage devices, or other tangible computer readable media. This can also include nontangible computer-readable media, such as data signals, data transmissions, or any other medium which can be used to transmit the desired information and which can be accessed by computer system 200.

By way of example, computer-readable storage media 216 may include a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM, DVD, and Blu-Ray® disk, or other optical media. Computer-readable storage media 216 may include, but is not limited to, Zip® drives, flash memory cards, universal serial bus (USB) flash drives, secure digital (SD) cards, DVD disks, digital video tape, and the like. Computer-readable storage media 216 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, DRAM-based SSDs, magneto-resistive RAM (MRAM) SSDs, and hybrid SSDs that use a combination of DRAM and flash memory based SSDs. The disk drives and their associated computer-readable media may provide non-volatile storage of computer-readable instructions, data structures, program modules, and other data for computer system 200.

Communications subsystem 232 may provide a communication interface from computer system 200 and external computing devices via one or more communication networks, including local area networks (LANs), wide area networks (WANs) (e.g., the Internet), and various wireless telecommunications networks. As illustrated in FIG. 2, the communications subsystem 232 may include, for example, one or more network interface controllers (NICs) 234, such as Ethernet cards, Asynchronous Transfer Mode NICs, Token Ring NICs, and the like, as well as one or more wireless communications interfaces 236, such as wireless network interface controllers (WNICs), wireless network adapters, and the like. Additionally and/or alternatively, the communications subsystem 232 may include one or more modems (telephone, satellite, cable, ISDN), synchronous or asynchronous digital subscriber line (DSL) units, Fire Wire® interfaces, USB® interfaces, and the like. Communications subsystem 236 also may include radio frequency (RF) transceiver components for accessing wireless voice and/or data networks (e.g., using cellular telephone technology, advanced data network technology, such as 3G, 4G or EDGE (enhanced data rates for global evolution), WiFi (IEEE 802.11 family standards, or other mobile communication technologies, or any combination thereof), global positioning system (GPS) receiver components, and/or other components.

In some embodiments, communications subsystem 232 may also receive input communication in the form of structured and/or unstructured data feeds, event streams, event updates, and the like, on behalf of one or more users who may use or access computer system 200. For example, communications subsystem 232 may be configured to receive data feeds in real-time from users of social networks and/or other communication services, web feeds such as Rich Site Summary (RSS) feeds, and/or real-time updates from one or more third party information sources (e.g., data aggregators). Additionally, communications subsystem 232 may be configured to receive data in the form of continuous data streams, which may include event streams of real-time events and/or event updates (e.g., sensor data applications, financial tickers, network performance measuring tools, clickstream analysis tools, automobile traffic monitoring, etc.). Communications subsystem 232 may output such structured and/or unstructured data feeds, event streams, event updates, and the like to one or more data stores that may be in communication with one or more streaming data source computers coupled to computer system 200.

The various physical components of the communications subsystem 232 may be detachable components coupled to the computer system 200 via a computer network, a FireWire® bus, or the like, and/or may be physically integrated onto a motherboard of the computer system 200. Communications subsystem 232 also may be implemented in whole or in part by software.

Due to the ever-changing nature of computers and networks, the description of computer system 200 depicted in the figure is intended only as a specific example. Many other configurations having more or fewer components than the system depicted in the figure are possible. For example, customized hardware might also be used and/or particular elements might be implemented in hardware, firmware, software, or a combination. Further, connection to other computing devices, such as network input/output devices, may be employed. Based on the disclosure and teachings provided herein, a person of ordinary skill in the art will appreciate other ways and/or methods to implement the various embodiments.

There is presently a need, possessed both by early-career graduates seeking employment and by presently employed persons seeking to advance their role within their organization, to obtain experiential (i.e., not just theoretical) skills training, and, upon learning skills through such training, to obtain some form of credential to prove their competency in those skills.

For example, upon completion of their undergraduate education, a person seeking a job may possess a wealth of theoretical knowledge in their particular area of study, but may not possess either the ability or proof of their ability to apply their theoretical knowledge in the real-world. Additionally, it may be beneficial to define the person's present skill set via baseline assessments, analysis of their undergraduate coursework, self-reporting, or some combination of these.

As another example, an employee of an organization may wish to progress to a higher role within the organization, but may lack either the skills or proof of their possession of the skills that are requisite to be placed in that role. Additionally, the employee may be able to identify the role that they want within their organization, but may not be aware of the particular skills needed to succeed within the desired role or how such skills could and should be obtained (e.g., potentially including the order in which the skills should be obtained). Thus, in addition to the need for specific skills training for employees, there also exists a need to identify a skills path defining the skills that the employee needs to obtain to reach their goal and one or more sequences in which the skills could or should be required, based on the employee's present skill set. Additionally, it may be beneficial to define the employee's present skill set via baseline assessments, manager feedback, employee self-reporting, or some combination of these.

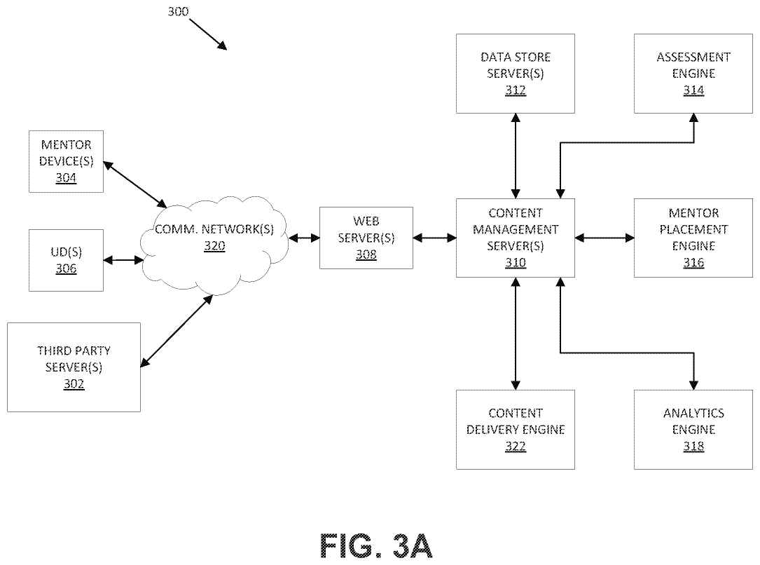

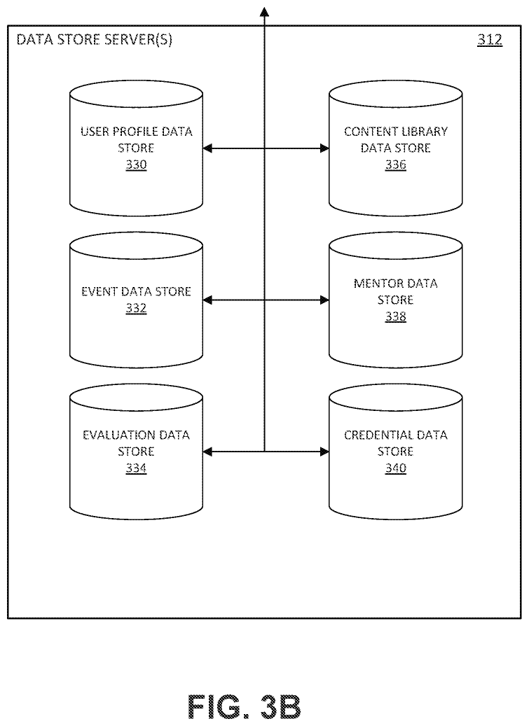

FIG. 3A shows an illustrative block diagram of a system 300 which may perform skill and goal analysis of a user, deliver course (e.g., experiential training) recommendations for the user based on the skill and goal analysis, deliver courses to the user (e.g., to provide experiential training to the user), validate that the user has acquired corresponding skills upon completion of the courses, and issue credentials to the student upon successful validation. For example, the system 300 may be or may include an experiential digital learning system.

As shown, the system 300 may include one or more web servers 308, content management servers 310, data store servers 312, assessment engines 314, mentor placement engines 316, analytics engines 318, and content delivery engines 322.

Any or all of the assessment engine 314, the mentor placement engine 316, the analytics engine 318, and the content delivery engine may be implemented by executing computer-readable instructions with one or more processors of one or more servers of the system 300, which may include the content management servers 310, or other servers that are separate from the content management servers (not shown; e.g., servers 112, FIG. 1).

The web servers 308 (e.g., which correspond to at least a subset of the servers 102, 112 of FIG. 1) may be communicatively coupled to one or more user devices (UDs) 306, mentor devices 304, and third party servers 302 via one or more communication networks 320 (e.g., network 120 of FIG. 1). For example, the web servers 308 may include hyper-text transfer protocol (HTTP)) servers, web application programming interface (API) servers, and the like. For example, the web servers 308 may handle incoming and outgoing network traffic, may pass incoming data to the resource management servers 310, and may pass outgoing data to the communication network 320 to be routed to a destination mentor device 304, UD 306, or third party server 302.

For example, the web servers 308 may provide cross-domain and/or cross-platform web services in accordance with various web service standards, such as RESTful web services (i.e., services based on the Representation State Transfer (REST) architectural style and constraints), and/or web services designed in accordance with the Web Service Interoperability (WS-I) guidelines. Some web services may use the Secure Sockets Layer (SSL) or Transport Layer Security (TLS) protocol to provide secure connections between the web servers 308 and user devices 306. SSL or TLS may use HTTP or HTTPS to provide authentication and confidentiality. In other examples, web services may be implemented using REST over HTTPS with the OAuth open standard for authentication, or using the WS-Security standard which provides for secure SOAP messages using XML encryption.

The content management servers 310 (e.g., servers 102, FIG. 1; system 200, FIG. 2) may include any applicable type of server including, for example, a rack server, a tower server, a miniature server, a blade server, a mini rack server, a mobile server, an ultra-dense server, a super server, or the like, and may include various hardware components, for example, a motherboard, a processing unit, memory systems, hard drives, network interfaces, power supplies, etc. Content management server 310 may include one or more server farms, clusters, or any other appropriate arrangement and/or combination of computer servers. Content management server 310 may act according to stored instructions located in a memory subsystem of the content management server 310, and may run an operating system, including any commercially available server operating system and/or any other operating systems discussed herein. The content management servers 310 may provide instructions to and receive information from the other devices within the system 300, in order to manage and transmit content resources, user data, and server or client applications executing within the system 300.

The data store server(s) 312 (e.g., servers 112 including data stores 110 of FIG. 1) may be communicatively coupled to the content management servers 310. Turning to FIG. 3B, a diagram is shown, illustrating different data stores 330-340 that may be included in the data store server(s) 312. As shown, the data store servers 312 may include a user profile data store 330, an event data store 332, an evaluation data store 334, a content library data store 336, a mentor data store 338, and a credential data store 340.

The paragraphs below describe examples of specific data stores that may be implemented within some embodiments of the system 300. It should be understood that the below descriptions of data stores 330-340, including their functionality and types of data stored therein, are illustrative and non-limiting. Data stores server architecture, design, and the execution of specific data stores 330-348 may depend on the context, size, and functional requirements of the system 300. For example, in professional training and educational applications, separate databases or file-based storage systems may be implemented in data store server(s) 312 to store trainee and/or student data, trainer and/or professor data, training module data and content descriptions, training results, evaluation data, and the like. In applications involving media distribution from content providers to subscribers, separate data stores may be implemented in data stores server(s) 312 to store listings of available content titles and descriptions, content title usage statistics, subscriber profiles, account data, payment data, network usage statistics, etc.

The user profile database 330 can include user metadata relating to a user's status, location, or the like. This information can identify, for example, a device a user is using, the location of that device, or the like. In some embodiments, this information can be generated based on any location detection technology including, for example, a navigation system, or the like. The user profile database 330 can include user metadata identifying communication information associated with users identified in the user profile database 330. This information can, for example, identify one or several devices used or controlled by the users, user telephone numbers, user email addresses, communication preferences, or the like.

Information relating to the user's status can identify, for example, logged-in status information that can indicate whether the user is presently logged-in to the system 300 and/or whether the log-in-is active. In some embodiments, the information relating to the user's status can identify whether the user is currently accessing content and/or participating in an activity from the content distribution network 330.

In some embodiments, information relating to the user's status can identify, for example, one or several attributes of the user's interaction with the system 300, and/or content distributed by the system 300. This can include data identifying the user's interactions with the system 300, the content consumed by the user through the system 300, or the like. In some embodiments, this can include data identifying the type of information accessed through the system 300 and/or the type of activity performed by the user via the system 300, the lapsed time since the last time the user accessed content and/or participated in an activity from the system 300, or the like. In some embodiments, this information can relate to a content program (e.g., course) comprising an aggregate of data, content, and/or activities, and can identify, for example, progress through the content program, or through the aggregate of data, content, and/or activities forming the content program. In some embodiments, this information can track, for example, the amount of time since participation in and/or completion of one or several types of activities, the amount of time since communication with a mentor device 304 associated with a mentor assigned to the user, and/or the like.

In some embodiment, the user profile database 330 can further include user metadata relating to the users' academic and/or educational history. This information can identify one or several courses of study that the user has initiated, completed, and/or partially completed, as well as grades received in those courses of study. In some embodiments, the student's academic and/or educational history can further include information identifying student performance on one or several tests, quizzes, and/or assignments.

The user profile database 330 can include user metadata identifying one or several skills and, optionally, corresponding user skill levels possessed by users. In some embodiments, such user skill levels can identify a user's proficiency in a given skill based on the user's past performance in interacting with the system 300. In some embodiments, such user skill levels can identify a predicted skill level determined based on the user's past performance in interacting with the system 300 (e.g., by processing features characterizing the user's past performance or other applicable characteristics of the user with one or several predictive models, such as machine learning models). In some embodiments, skills possessed by the user may be determined based on the user's responses to one or more baseline assessments (e.g., designed to assess general skill proficiency or specific skill levels), as will be explained. In some embodiments, a third party (e.g., the user's supervisor or manager) may endorse the user as possessing a general or specific level of proficiency in one or more skills. In some embodiments, skills associated with a user in the user profile database 330 may be defined via self-report by the user, which may be helpful when identifying skills that are not easily quantifiable.

In some embodiments, a user may take one or more courses via the system 300 specifically to develop one or more skills and, upon successful completion of such courses, the associated skills may be recorded in the user profile database as being possessed by the user. For example, “successful completion” of a course require the user to score a sufficiently high grade (e.g., exceeding a predefined threshold) on one or more summative assessments of the course, may require the user to score sufficiently high (e.g., exceeding one or more predefined thresholds) on individual or collective sections of a rubric associated with the course, and/or may require the user to receive positive feedback from a mentor assigned to the student through the duration of the course.

The user profile database 330 can further include user metadata describing attributes of the user, such as the user's goals, field of work, learning style, and other applicable attributes.

The event data store 332 may include information identifying one or several interactions between a user of the user device 306 and other devices of the system 300. For example, the event data store may include activity metadata characterizing interactions between a user and the system 300. For a given user, the activity metadata may include, but is not limited to: a characterization of randomness in the responses submitted by the user (e.g., in the form of a Hurst coefficient); one or more average “correct on first try” percentages for an assessment or aggregated from many assessments; an average score/grade which can include an average homework score and/or an average test score in a given course; an average item part score; a number of attempted item parts; an average number of attempted item parts; an average number of attempts per item part; and an aggregation parameter such as, for example, one or several course level aggregations. It should be understood that herein an “item part” refers to the smallest divisible part of a question to which a user may submit an answer. Some questions/items may include multiple parts, while others may only include a single part.

In some embodiments, these elements of activity metadata can be calculated with data collected within a window, which window can be a temporally bounded window, or a window bounded by a number of received responses. In such an embodiment, for example, the window can be a sliding window, also referred to herein as a sliding temporal window that can include information relating to some or all of one or several users' interaction with the system 300 during a designated time period such as, for example, a one week time period, a ten day time period, a two week time period, a three week time period, a four week time period, a six week time period, a twelve week time period, or any other or intermediate period of time.

The evaluation data store 334 may include information used to direct the evaluation of users and content resources in the system 300. In some embodiments, the evaluation data store 334 may contain, for example, the analysis criteria and the analysis guidelines for evaluating users (e.g., trainees/students, gaming users, media content consumers, etc.) and/or for evaluating content resources. The evaluation data store 334 also may include information relating to evaluation processing tasks, for example, the identification of users and user devices 306 that have received certain content resources or accessed certain applications, the status of evaluations or evaluation histories for content resources, users, or applications, and the like. Evaluation criteria may be stored in the evaluation data store 334 including data and/or instructions in the form of one or several electronic rubrics or scoring guides for use in the evaluation of the content, users, or applications. The evaluation data store 308 also may include past evaluations and/or evaluation analyses for users, content, and applications, including relative rankings, characterizations, explanations, and the like.

The content library data store 336 may include information describing the individual content items (or content resources or data packets) available via the system 300. In some embodiments, these data packets in the content library database 336 can be linked to form an object network. In some embodiments, these data packets can be linked in the object network according to one or several sequential relationship which can be, in some embodiments, prerequisite relationships that can, for example, identify the relative hierarchy and/or difficulty of the data objects. In some embodiments, this hierarchy of data objects can be generated by the system 300 according to user experience with the object network, and in some embodiments, this hierarchy of data objects can be generated based on one or several existing and/or external hierarchies such as, for example, a syllabus, a table of contents, or the like. In some embodiments, for example, the object network can correspond to a syllabus such that content for the syllabus is embodied in the object network.

In some embodiments, the content library data store 336 can comprise a syllabus, a schedule, or the like. In some embodiments, the syllabus or schedule can identify one or several tasks and/or events relevant to the user. In some embodiments, for example, when the user is a member of a group such as a section or a class, these tasks and/or events relevant to the user can identify one or several assignments, quizzes, exams, or the like.

In some embodiments, the content library data store 336 may include metadata, properties, and other characteristics associated with content resources associated with one or more courses. Such data may identify one or more aspects or content attributes of the associated content resources, for example, subject matter, access level, or skill level of the content resources, license attributes of the content resources (e.g., any limitations and/or restrictions on the licensable use and/or distribution of the content resource), price attributes of the content resources (e.g., a price and/or price structure for determining a payment amount for use or distribution of the content resource), rating attributes for the content resources (e.g., data indicating the evaluation or effectiveness of the content resource), and the like. In some embodiments, the content library data store 336 may be configured to allow updating of content metadata or properties, and to allow the addition and/or removal of information relating to the content resources. For example, content relationships may be implemented as graph structures, which may be stored in the library data store 336 or in an additional store for use by selection algorithms along with the other metadata.

In some embodiments, the content library data store 336 may include the content resources themselves, which may include question banks and/or definitions for delivery methods for quizzes, tests, and other assessments, training materials, presentations, plans, syllabi, reviews, evaluations, interactive programs and simulations, course models, course outlines, and various training interfaces that correspond to different materials and/or different types of user devices 306. For applications of the system 300 that involve media distribution, interactive gaming, and the like, the content library data store 336 may include media content files such as music, movies, television programming, games, and advertisements.

In some embodiments, the content library data store 336 can contain information used in evaluating responses received from users. In some embodiments, for example, a user can receive content from the system 300 (e.g., via the content delivery engine 332) and can, subsequent to receiving that content, provide a response to the received content. In some embodiments, for example, the received content can comprise one or several questions, prompts, or the like, and the response to the received content can comprise an answer to those one or several questions, prompts, or the like. In some embodiments, information, referred to herein as “comparative data,” from the content library data store 336 can be used to determine whether the responses are the correct and/or desired responses.

In some embodiments, the content library database 336 and/or the user profile database 330 can comprise an aggregation network, also referred to herein as a content network or content aggregation network. The aggregation network can comprise a plurality of content aggregations that can be linked together by, for example: creation by common user; relation to a common subject, topic, skill, or the like; creation from a common set of source material such as source data packets; or the like. In some embodiments, the content aggregation can comprise a grouping of content comprising the presentation portion that can be provided to the user in the form of, for example, a flash card and an extraction portion that can comprise the desired response to the presentation portion such as for example, an answer to a flash card. In some embodiments, one or several content aggregations can be generated by the system 300 and can be related to one or several data packets that can be, for example, organized in object network. In some embodiments, the one or several content aggregations can be each created from content stored in one or several of the data packets.

The mentor data store 338 may include a listing of available mentors (e.g., a “mentor pool”) that can be assigned to a user who is enrolled in a course for which mentorship is required. The mentor data store 338 may include mentor metadata, which may define characteristics of a given mentor, based on which the mentor may be matched with a user (e.g., by the mentor placement engine 316). For example, the mentor metadata may define the geographic location, industry experience (e.g., which may include listings of current and/or past employers), course and/or subject matter preferences for mentorship, skills, and/or respective skill levels, of a mentor. Additionally, each mentor in the mentor pool may be associated with one or more mentor devices 304 (e.g., according to internet protocol (IP) address or media access control (MAC) address associated with such a mentor device).

The credential data store 340 may include a record of credentials that may be issued to users by the system 300, a record of which users have earned each credential, and a record of the requirements that must be met by any given user before a given credential may be issued to that user. For example, credentials can include certifications that users can earn through successfully completing individual courses, certifications earned through successfully completing individual courses and passing associated certification assessments, statements of participation in individual courses, and the like. In some embodiments, the content management servers 310 may periodically communicate with third party servers 302 with updated information regarding user credentials. For example, if a user has permitted (e.g., via configuration of settings in their user profile) the system 300 to provide credential data to a third party application or website, the content management servers 310 may retrieve corresponding credential data for that user from the credential data store 340 and may send the credential data to associated third party servers 302 via the web servers 308 and communication networks 320. The content management servers 310 may send credential data updates to the third party servers 302 periodically and/or upon determining that relevant credential data has changed since last communicated to the third party servers 302.

Returning to FIG. 3A, the assessment engine 314 may deliver assessments (e.g., quizzes, exams, homework assignments, etc.) to the user devices 306, and may process responses submitted to assessment questions via the user devices 306. For example, when delivering a given assessment, the assessment engine 314 may first retrieve questions from an associated question bank (e.g., from the content library data store 336 of the data store servers 312). The assessment engine 314 may then cause (e.g., via communication via the content management servers 310, web servers 308, and/or communication networks 320) the questions to be displayed at the user device 306 at which the assessment is being delivered, either in a predefined order, or in a random order, depending on defined attributes of the assessment being delivered. The assessment engine 314 may receive (e.g., via communication via the content management servers 310, web servers 308, and/or communication networks 320) responses submitted at the UD 306. The assessment engine 314 may cause these responses to be stored at a location (e.g., within a database) within a memory device (e.g., evaluation data store 344 or event data store 342 of the data store servers 312), the location being associated with the particular assessment delivery event. The assessment engine 314 may determine and store a score (e.g., corresponding to the response being correct, incorrect, partially correct, etc.) for each response. For example, the assessment engine 314 may determine the score via reference to an associated, predetermined correct response stored in memory, such as in the content library data store 336. In some embodiments, response scores may be determined manually by an instructor or evaluator (e.g., according to a rubric), and may then be uploaded to the assessment engine 314 for entry into memory. In some embodiments, when the assessment ends, unanswered questions of an assessment may be automatically assigned a score of zero. Upon completion of the assessment (e.g., in response to the assessment being submitted by a user via interaction with the user device 306, or in response to a time limit associated with the assessment delivery event having elapsed), the assessment engine 314 may generate one or more grades for the assessment based on the scores determined for each response.

The assessment engine 314 may deliver one or more baseline assessments to determine the respective skill level of a user with respect to one or more skills. For baseline assessments, the “grade” determined by the assessment engine 314 may be translated into an estimated skill level of the user for a given skill. In addition to identifying a user's skill proficiency/skill level, these baseline assessments may also identify whether a user possesses a given skill or set of skills at all. For example, if a job for which a user wishes to apply requires a set of skills A, B, and C, the user may seek to obtain credentials in skills A, B, and C. As an initial step, the assessment engine 314 may deliver baseline assessments to verify the user's proficiency in skill A, in skill B, and in skill C. In some embodiments, respectively separate baseline assessments may be delivered for each skill being evaluated, while in other embodiments, if applicable, two or more skills may be evaluated via a single baseline assessment. As will be described, a skill path may be established for the user (e.g., by the analytics engine 318) identifying skills that the user should acquire or develop in order to better qualify for their goal job/role.

The assessment engine 314 may deliver one or more formative assessments to a user as the user progresses through a course in which the user is enrolled. The formative assessments may evaluate the user's understanding of newly introduced concepts as they are being taught, for example.

The assessment engine 314 may deliver one or more summative assessments to a user as the user reaches one or more progress thresholds via their progression through a course in which the user is enrolled. The summative assessments may evaluate how well the user has learned concepts taught by the course as a whole, or within a particular section of the course. In some embodiments, the results of the summative assessment(s) within a course may be the basis for determining whether the user will receive a credential for their participation in the course.

In some embodiments, the assessment engine 314 may deliver one or more post-course assessments to a user to verify that the user has retained information learned during a course in which they were previously enrolled. For example, an employer may have an employee take a course to develop a particular skill, and may wish to verify that the employee has retained the skill following the course. A high grade on such post-course assessments may therefore confirm to the employer that the user has successfully retained the skill or skills learned during the course. Conversely, a low grade on such post-course assessments may indicate to the employer that the user may need to be re-trained in the skill or skills due to lack of retention.

The mentor placement engine 316 may analyze characteristics of a user and characteristics of a number of mentors within the mentor pool of the mentor data store 338. For example, the mentor placement engine 316 may perform a statistical analysis or apply an artificial intelligence model, such as a machine learning model, to characteristics of the user retrieved from the user profile data store 330 and to characteristics of mentors retrieved from the mentor data store, and may identify a “best match” between the user and one of the mentors that is found to have relevant characteristics that are most similar to those of the user. Alerts may be sent to the user's user device 306 and the mentor's mentor device 304 by the content management servers 310 via the web servers 308 and communication networks 320, the alerts indicating the match between the user and the mentor. In some embodiments, the mentor or the user may accept or decline the match via interaction with their respective mentor device 304 or user device 306.

The analytics engine 318 may retrieve user metadata for a given user from the user profile data store 330, and may analyze this data to generate a skill path for the user. For example, the analytics engine 318 may identify the user's goal (e.g., a desired job or role being offered by an employer) from the user metadata, may identify a “skill gap” between the user's skills and/or skill levels and the skills and/or skill levels required to achieve the user's goal (e.g., prerequisite skills needed to qualify the user for the desired job or role).

For example, the analytics engine 318 may determine via analysis of a job posting associated with the user's goal that the corresponding job requires demonstrated experience/training in planning, communication, decision making, delegation, problem solving, and motivating subordinates. The analytics engine 318 may analyze the user metadata of the user, and may identify that the user already possesses demonstrated experience in planning, communication, and decision making, and has undergone training in delegation, but does not possess any experience, training, or credentials for problem solving and motivating subsidiaries. Based on this identified skill gap, the analytics engine 318 may determine that the user could meet the requirements for the desired job if they received training in problem solving and motivating subordinates. The analytics engine 318 may then generate and send a recommendation to the user device 306 of the user, indicating that the user should enroll in two courses, one providing experience and training in problem solving, and the other providing experience and training in motivating subordinates.

In some embodiments, the analytics engine 318 may analyze assessment results (e.g., retrieved from the evaluation data store 334) for an assessment taken by a user, the assessment providing evaluation of whether the user possesses a skill, and the user's corresponding skill level. The analytics engine 318 may determine the skill level of the user in the skill via this analysis. The analytics engine 318 may cause the determined skill level to be stored in the user profile data store 330 in connection with the user.

The content delivery engine 322 may deliver content resources for a course (e.g., formative and summative assessments, activities, presentations, guided discussion, scenarios, videos, games, syllabi, objectives, reflections, and/or the like) to a user device 306 of a user enrolled in that course and/or to a mentor device 304 of a mentor that has been assigned to that user. Such resources may be delivered by the content delivery engine 332 via the content management servers 310, web servers 308, and communication networks 320. The content delivery engine 322 may deliver content resources according to a given user's progress through a course in which they are enrolled, which may be monitored by the content management servers 310 and/or the analytics engine 318.

Any of the third party servers 302, the mentor devices 304, the UDs 306, the front-end servers 308, the content management servers 310, the data store servers 312, the assessment engines 314, the mentor placement engines 316, the analytics engines 318, and the content delivery engines 322 may be or may be implemented by computer systems similar to the system 200 of FIG. 2.

FIG. 4 shows an illustrative process flow of a method 400 by which, based on the goals and abilities of a user, the user may be provided with experiential training, and may subsequently be validated and provided with credentials confirming that they have acquired one or more skills and/or associated practical experience via the experiential training. The method 400 may, for example be performed via the execution of computer-readable instructions via one or more computer processors (e.g., processors 204 of FIG. 2), which may be included in one or more computer servers (e.g., servers 102, 112, 308, 310, 312, FIGS. 1, 3; device 200, FIG. 2) in communication with one or more data stores (e.g., data stores 110, 330, 332, 334, 336, 338, 340, FIG. 3B). The steps of the method 400 are described as being performed using one such processor, though it should be understood that multiple processors may be used. Examples of how the steps of the method 400 can be applied are provided in the context of FIGS. 3A and 3B and corresponding reference numerals are therefore used. In some embodiments, the computer-readable instructions may define one or more sequences in which content, courseware, data, assessments, and/or other interactives are presented to users in connection with the method 400.

At step 402, a processor defines a skill path for a given user. For example, a user of one of the user devices 306 may identify a goal, and may cause the goal to be entered into their user profile within the user profile database 330. The goal may define a job or role that the user wishes to obtain. The analytics engine 318 may identify a skill gap between the skills and skill levels possessed by the user based on the user metadata of the user included in the user profile database 330, and the skills and skill levels required in order to obtain the job (e.g., which may be submitted by the user when defining the corresponding goal). The analytics engine 318 may identify which skills the user needs to acquire or improve in order to qualify for the desired job, and may identify courses in which the user can enroll in order to obtain or improve these skills. A listing of these identified courses and their corresponding skills may be compiled into a skill path, which may define an order in which the user may take and complete courses in order to obtain (i.e., learn) or improve “untrained” skills. Here, “untrained” skills refer to skills of a skill path for which the user has not yet undergone and successfully completed a corresponding course defined for that skill in the skill path. In some embodiments, a given skill may require training via multiple courses in order to reach the skill level required by a particular job, and in such cases, the skill may continue to be considered “untrained” for the purposes of the method 400 until the user has successfully reached the required skill level (e.g., by completing all of the corresponding courses).

At step 404, the processor selects an untrained skill from the skill path. For example, this selection may be performed in response to a manual selection of the untrained skill by the user via interaction with the user device 306. Alternatively, this selection may be performed automatically, with the processor selecting the next untrained skill from the skill path according to a predefined order. Selection of an untrained skill in this way may cause the processor to enroll the user in a course that provides training (e.g., experiential training) in the untrained skill, which will now be referred to as the “selected skill”.

At step 406, the processor causes course content to be delivered to the user, corresponding to the course in which the user was enrolled following selection of the untrained skill. For example, such course content may be delivered via the content delivery engine 322.

In some embodiments, a mentor may be assigned to the user prior to initiating delivery of course content. For example, the mentor placement engine may identify a mentor that is a “best match” for the user, according to characteristics of the user defined in the user metadata for the user stored in the user profile data store 330 and according to characteristics of the mentor defined in mentor metadata for the mentor stored in the mentor data store 338. In some embodiments, this match may be determined by processing the user's characteristics and multiple mentors' respective characteristics in order to identify which mentor is most characteristically similar to the user, as pertains to the course in which the student is enrolled. For example, statistical methods or artificial intelligence models such as machine learning models may be executed to process the mentor metadata and the user data to generate a number of similarity scores for each user-mentor pair, and the mentor corresponding to the highest similarity score may be identified as the “best match” for the user. The mentor and user may collaborate to define success criteria for the course, and the mentor may provide guidance (e.g., derived from the mentor's practical experience) to the user as they progress through the course.

In some embodiments, a course delivered at step 406 may be split into multiple sections of two section types. The first section type may be a “skill practice” section, while the second section type may be a “skill pilot” section. A given skill practice section may involve providing (e.g., via the content delivery engine 322) the user with presentations of skill-related concepts, active learning activities related to the skill being trained, and problem based scenarios and activities that allow the user to apply the skill being trained and skill-related concepts in the context of specific, albeit simulated, situations. Formative assessments may be delivered to the user (e.g., via the assessment engine 314) at defined intervals as the user progresses through the course, and the results of these formative assessments may identify concepts that the user has failed to learn or that otherwise need reinforcement/remediation within the course. This may allow the course progression to be dynamically adjusted, in some embodiments, to focus on concepts with which the user struggles.

A given skill pilot section may similarly involve providing (e.g., via the content delivery engine 322) the user with skill-related concepts, presentations, and activities. However, the skill pilot section differs from the skill practice section in that it serves as a real-world “test drive” of the skill or skills acquired in the skill practice section. For example, the user may collaborate with their mentor through guided discussion and planning (e.g., guided via content provided via the content delivery engine 322), and may then apply the selected skill in a real-world scenario, potentially having actual consequences. For example, in training information technology network design skills, the real-world scenario could include the user designing a computer network for an actual client (e.g., a client of the mentor's), according to specifications defined by the client. Following this real-world application, the mentor may provide feedback to the user. In some embodiments, this feedback may impact whether the user successfully completes the course.

It should be understood that some courses may include only skill practice sections, or only skill pilot sections, and are not generally required to include both section types.

Illustrative content (e.g., web pages and/or screenshots) from courses that may be delivered via the method 400 of FIG. 4 and/or using the system 300 of FIGS. 3A and 3B are shown in FIGS. 5A-5E. FIG. 5A shows a course description that may be displayed to a user to enable the user to enroll in a course in project management. FIG. 5B shows a course summary page that defines a challenge addressed during the project management course, and shows group members participating in the project management course with the user. FIG. 5C shows an activity scheduling page that may be included as part of the project management course. FIG. 5D shows a lesson page in a section of a negotiation course, which includes a video presentation on basic negotiation techniques. FIG. 5E shows a reflection page in a section of the negotiation course, which includes multiple prompts for guided reflection following the section's activity to which the user may submit responses.

Returning to FIG. 4, at step 408, which may be optional depending on the course, the processor causes one or more summative assessments to be delivered to the user (e.g., via the assessment engine 314). This may occur at the end of the user's progress through the course to verify either that the user has successfully learned the skill intended to be taught via the course, or to verify the skill level of the user following the course. In some embodiments, a baseline assessment may be delivered to the user prior to the course to assess the user's initial skill level. The initial skill level of the user determined by this baseline assessment may be compared to the final skill level of the user identified via the summative assessment at the end of the course, which may allow the system 300 to confirm whether the user's skill level has improved through taking the course. In some embodiments, a summative assessment grade exceeding a predetermined threshold may be required in order for the user to receive a credential corresponding to the course and/or in order for the course to be considered “successfully completed” by the user.

At step 410, the processor determines whether the user successfully completed the course. For example, successful completion of the course may be combined based on mentor feedback, summative assessment grade, a grade issued based on a rubric associated with the course, or a combination of these. If the user has successfully completed the course, the method proceeds to step 414. Otherwise, if the user did not successfully complete the course, the method proceeds to step 412.

At step 412, the processor causes a recommendation to be sent to the user. The recommendation may suggest alternative courses that could provide training in the skill, selection of which by the user may cause the skill path to be modified. The recommendation may suggest that the user re-take the course, and may provide the user with guidelines for improving their performance. For example, such guidelines may be generated based on mentor feedback and/or analysis of user interactions with the system 300 as they progressed through the course (e.g., as recorded in the event data store 332). The method then returns to step 404, at which an untrained skill and corresponding course are again selected. Note that these could be the same untrained skill and corresponding course that the user just failed to complete, or a different untrained skill and/or course could be selected.

At step 414, the processor determines whether a credential was earned by the user via successful completion of the course. For example, some courses may allow a user to earn credentials such as certificates or other acknowledgements of training, while others may not. If the user earned a credential through successfully completing the course, the method proceeds to step 416. Otherwise, the method proceeds to step 420.

At step 416, the processor causes the credential to be issued to the user. For example, the content management server 310 may cause the credential data store 340 and/or the user profile data store to be updated to reflect that the credential has been issued to the user.

At step 418, which is optional, the processor may cause a third party to be notified that the user has earned the credential. In some embodiments, the third party may be an authorized third party to which the user has provided permission to receive updates regarding credentials earned by the user. For example, the third party may be an employer of the user, or may be a professional social media website or application with which the user has an account.

At step 420, the processor determines whether all skills in the skill path have been successfully trained. For example, this condition may be fulfilled when the user has successfully obtained, via course enrollment and completion, the skills and skill levels required for the job or role defined in the user's goal. If all skills in the skill path have been successfully trained, the method proceeds to step 422. Otherwise, the method returns to step 404 and another untrained skill and corresponding course are selected.

At step 422, the processor sends a notification to the user (e.g., via electronic communication with the user device 306). The notification may indicate that the user has successfully earned the skills required to qualify for the job or role associated with the user's goal.

The disclosed embodiments, which utilize a skills focused approach, represent a significant improvement in the state of the art, by offering a suite of skills-based courses providing a learning pathway to a particular role, in order to specifically improve the learner's skills (e.g., becoming a project manager, managing stakeholders, etc.). To accomplish this, in some embodiments, the disclosed system identifies specific features of the mentor and mentee (e.g., recent college graduates, workers wanting upskill themselves to achieve workplace goals), and matches the specific features of the mentors with mentees in order to provide opportunities to achieve their professional or workforce goals, by applying their learning and experience to hypothetical and/or real world scenarios.

The disclosed embodiments may include 6 differentiators that represent an improvement over the prior art: 1. The disclosed embodiments use a “learn it, try it, use it” model to encourage experiential learning, vs passive courses that use only narrative or videos, for example; 2. The disclosed embodiments provide a learning experience utilizing regular mentor/mentee interaction, which provides rubric-based feedback; 3. The disclosed embodiments include skill-based courses covering specific skills areas, which may be combined with skills from other courses; 4. Potential employers may create the skills-based courses and therefore benefit from the skills taught; 5. The disclosed embodiments allow a learner user to complete the courses with certificates and/or credentials based on the skills taught in the course, which may benefit the learner user's portfolio, job search, etc.

The provider of the system described in the disclosed embodiments may generate and store skills based courses within data store 110 or within any memory accessible to the disclosed system. These courses may improve learner users' soft or professional skill sets (e.g., understanding/dealing with customers, improving business skills, managing projects, sales management, product or business development, etc.).

System users may include mentees/learner users and mentor users matched with the mentees to assist them by giving feedback on their work within the mentee's courses.

Learner users may access the system, and create a user account for mentees. After creating a user account, the mentee may access a landing page within a learning management system (e.g., PEARSON.COM) on which the disclosed system may display a course catalog listing all available courses.

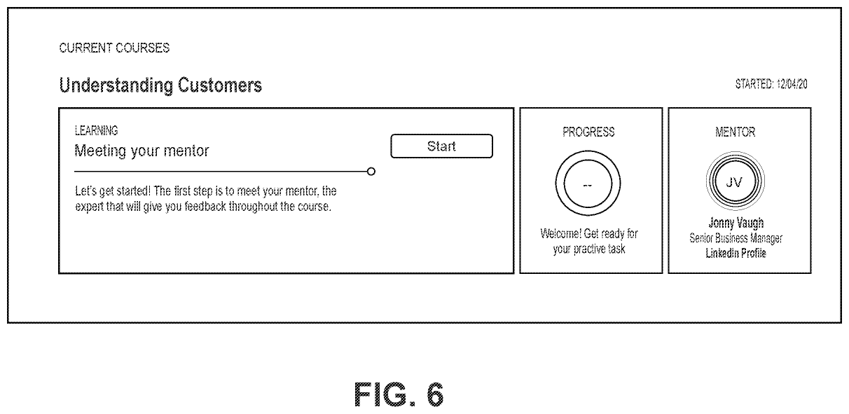

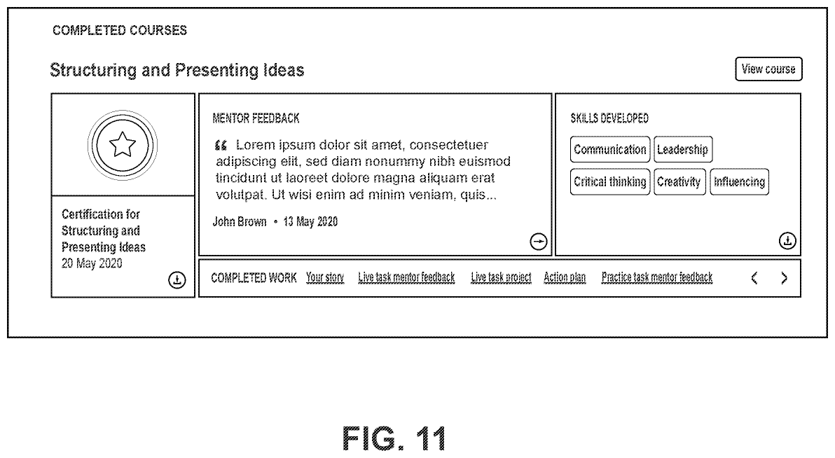

Once the learner has created their learner account and selected their courses, the disclosed system may generate a learner dashboard GUI such as that seen in FIG. 6, and display it to the user on client device 106. This dashboard may include a listing of all of the courses in which the learner has enrolled, as well as completed courses, as seen in FIG. 11.

As seen in FIG. 6, the disclosed system, possibly one or more processors on server 112 executing one or more algorithms within one or more software modules, may match the mentee with a mentor, as demonstrated in FIG. 6. For example, the mentor placement engine 316 may select the mentor from one or more mentors using the data records associated with mentors in the mentor data store 338, which may have been stored by one or more system administrators as a preliminary step.

The data stored in mentor data store 338 may also be entered by the mentor themselves. For example, a mentor may access the disclosed system, possibly via a mentor enrollment URL displayed on a GUI or other client software running on mentor device, 304. The mentor may then enter mentor data via a mentor dashboard, accessible to a mentor user after creating a mentor account with the disclosed system, and displayed on the mentor device 304. The mentor may also allow each mentor to access instructions for becoming a mentor, as well as a list of available courses and course descriptions, in order to determine the subject matter of the course, and whether the mentor is qualified for that course.

If qualified, the mentor may enroll, associating themselves with the courses selected from the mentor dashboard. In various embodiments, the mentor may need to enter personal data (name, geographic location, current job title, expertise, skills, courses, certifications, LinkedIn URL, etc.), as well as other verification data for the mentor's credentials. Once enrolled, the mentor may validate to the disclosed system, review training materials (e.g., a training video) and agree to various mentoring agreements, including terms of use, confidentiality, privacy, expectations, and the like.

The mentor may then input or select, possibly via the mentor dashboard, the courses that they for which they would like to act as a mentor, and the disclosed system logic may then store the mentor's selected courses within the data store 110, possibly mentor data store 338. If needed, the mentor may also access the course content for the selected courses.

As seen in FIG. 6, once the mentor completes the enrollment process, the disclosed system may then use the expertise data provided by the mentor user to create a map within the mentor data store 338 and/or system logic between the mentor data and the courses offered within the disclosed system. As a non-limiting example, the system may flag specific skills identified and input by the user, and stored within database 110, and may match this with metadata associated with the courses that identify the same skills. The system may then associate the mentor user, the mentor's skills, and one or more courses for which the mentor user has selected to act as mentor.

Similarly, the disclosed system may create a map between the geography identified and input by the mentor, and the geography of a new learner/mentee that has enrolled in a course for which the system has identified the mentor for that course. Once the common course has been identified, the disclosed system may identify the geographical location input by the mentor, and compare that with a geographical location identified for the mentee. If the course and the geographical location match, the system may assign the mentor as a potential mentor for the mentee for the selected course.

In some embodiments, the features of the mentor and mentee may not be limited to a selected course and geography. In these embodiments, the data logic of the disclosed system, possibly within the mentor placement engine 316, may consider any features of the mentor and mentee, so that the system may receive any data relating to features of either the mentor or the mentee via the user device 306 and the mentor device 304, for example. In these embodiments, the system may receive user input defining one or more features for the mentor and the mentee. For each of the mentor and the mentee, the system logic may then convert each of the features into a numeric value, and combine the features for each of the mentor or mentee, to automatically generate a multi-dimensional array of features. This multi-dimensional array of features may then be automatically converted into a feature vector, and this feature vector may be plotted. The disclosed system logic may then analyze the feature vector for the mentee, and run analysis logic to compare it with the feature vector of each of a plurality of mentors. The system logic may determine a distance between the feature vector for the mentee, and each of the feature vectors for each of the plurality of mentors. The system logic may then select a best mentor based on the mentor with the feature vector at the lowest distance from the feature vector of the mentee.

In some embodiments, the system logic may select the mentor based on a plurality of stored mentor history data within the system, possibly stored within mentor data store 338. In these embodiments, the disclosed system logic may receive data from a mentor device 304, and execute database commands to store, in the database 110 and/or in system logic within memory, metadata associated with the performance of mentors. In some embodiments, this data is stored as tags or metadata associated with the mentor, in the mentor data store 338. In these embodiments, the system logic may determine, based on one or more mentor features associated with the history of each of the mentors and derived from these tags or metadata, which indicate whether a particular mentor has a higher performance or a lower performance during the performance history stored within the system.

For example, the disclosed system may analyze one or more features, tags, and/or metadata associated with the mentor, and generate a mentor performance score, wherein a mentor with a higher mentor score is more likely to be selected as a mentor for a particular mentee user. In determining which mentor to assign to a particular mentee, the disclosed system may identify a plurality of mentors that have matching features or other data within the system, and are therefore a good match for the mentee, score each of these mentors based on their performance history, and assign the mentor with the highest performance score to the mentee. In some embodiments, the disclosed system may match learners with mentors according to additional various characteristics. As non-limiting examples, this may include the goals and/or specific needs of the learner mentees, the strengths and/or interests of both the mentor and the mentee, and/or by industry sector (e.g., the discloses system matches a learner that wants to work in retail with a mentor in retail).

Returning to FIG. 6, the mentee dashboard may display the user's course, the user's progress in the course, and the mentor assigned to the mentee for this course. In some embodiments, additional data about the assigned mentor may be displayed, possibly the data stored in the mentor data store (e.g., mentor's name, biographical data, links to a LinkedIn profile, a biographical video, an introduction email, etc.).

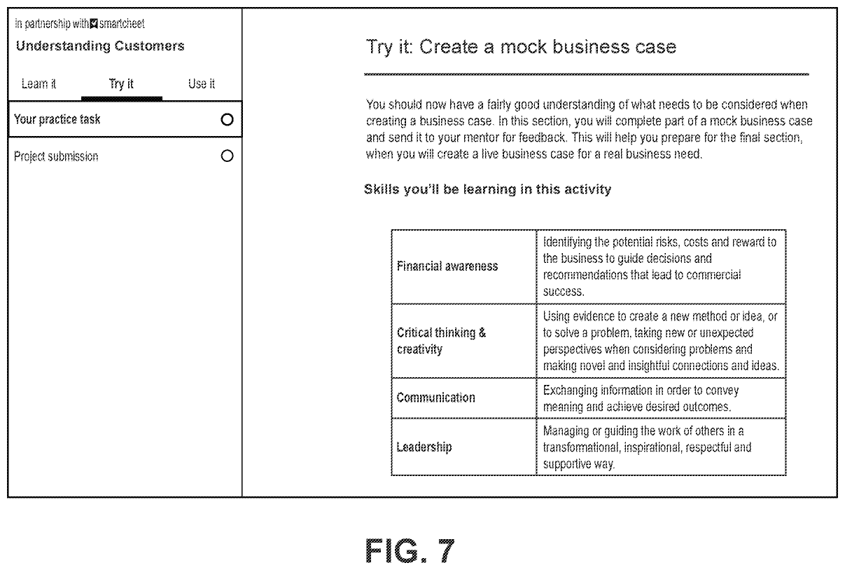

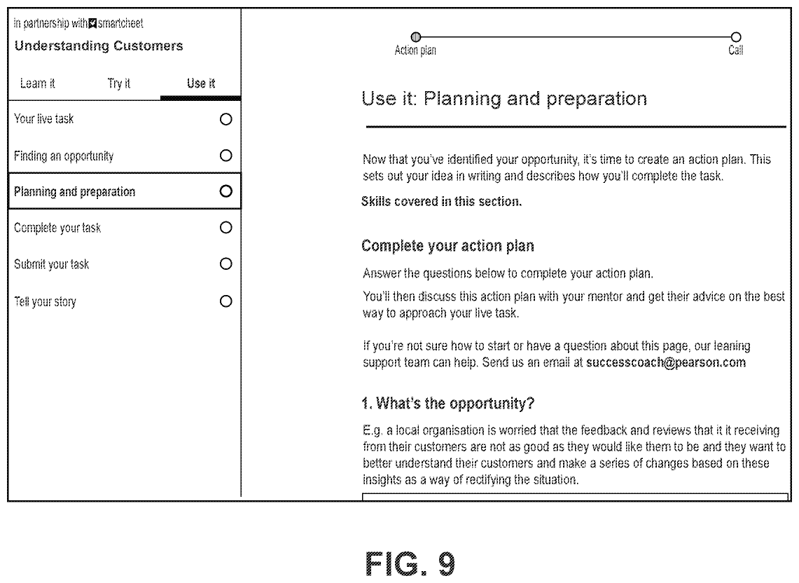

As demonstrated in FIGS. 7 and 9, the disclosed embodiments may include a format that reinforces a “learn it, try it, use it” format, wherein, as the user proceeds through the course, they first learn the theory and skills for the course, then use the theory and skills as applied in varying degrees within the real world. For example, the user may apply their learning in hypothetical situations, then may apply it to real world scenarios, receiving feedback from their mentor during these steps. It should be noted that in some embodiments, the courses are self-paced, which may reflect the recommended structure for success. Furthermore, in some embodiments, the “use it” portion of the course may be the only portion of the course required for course completion.

As seen in FIGS. 7 and 9, the first phase in the experiential course includes a “learn it” portion of the course. During this first phase, the user may access materials (e.g., text and instructional videos) teaching the theory and foundational principles within the course, using a user interface presenting the user with the structure of the course, specifically calling out the skills that the learners are using. These foundational principles may include the context, key terms, methodology and the like. In some embodiments, the “learn it” phase may include one or more assessments, such as multiple choice questions that provide an automated determination of whether the multiple choice questions reflect a correct or incorrect learning of the material the learner user has reviewed, in order to test the learning of the mentee learner. In some embodiments, the course may be co-developed with an industry partner to provide real world instruction, examples, employee instruction, etc.

As shown in FIG. 6, after completing the “learn it” phase, the mentee learner may move to a the “try it” phase, where the user applies their knowledge from the learning phase to a practice task, which may be one or more hypothetical scenarios, possibly developed by a third party partner to provide authentic examples and real-world tips, which the mentee learner user must work through, putting the principles and skills from the learn it phase into practice. As a non-limiting example, a hypothetical scenario may include being a client manager that must draft a plan to help a customer to achieve their goals, with the necessary details to accomplish the task (i.e., background information). As seen in FIG. 7, the “try it” phase may be comprised of two steps: understanding and drafting the practice task (e.g., writing a two page paper), and project submission, where the learner submits their work.

After completing the project according to the instructions, the learner may submit the project to receive feedback from the mentor. As a preliminary step to receiving feedback, the learner may complete a self-review. In some embodiments, this may include providing responses to pre-formulated questions in a GUI form, such as what they feel they did and did not do well to better understand their skill level. The learner then uploads the created artifact, which is then submitted to the mentor through the system.

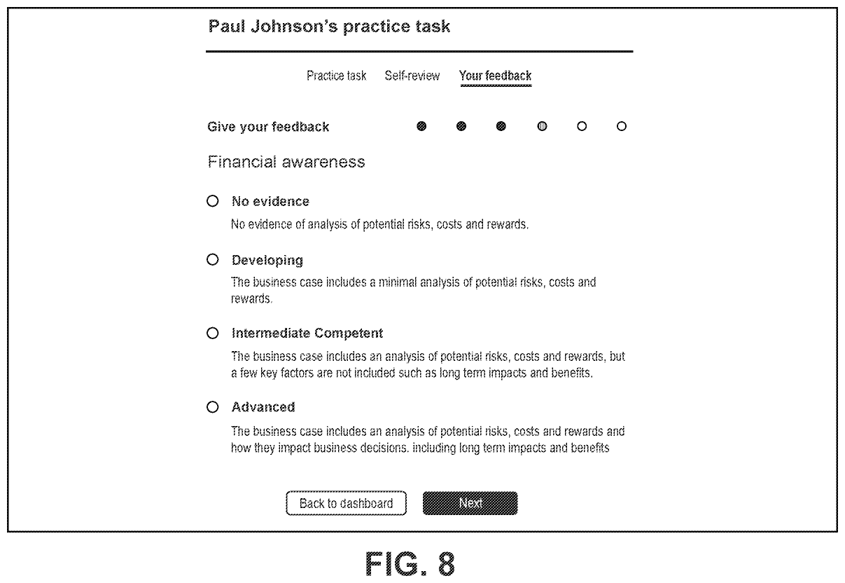

Turning now to FIG. 8, in response to the learners uploading their practice task from the “try it” phase, the mentor dashboard may be updated to alert the mentor. System logic may populate the mentor dashboard to include all mentees associated in the system with the mentor, and their associated courses. The mentor may therefore use the mentor dashboard to receive notifications (or may receive notifications via email) and determine the mentee learner user's progress within the course (e.g., submission of a practice task, need to review a mentee's self-review, or providing mentor feedback, as seen in FIG. 7).

The mentor may review the mentee's submission, as well as their self-review, and provide feedback for the mentee's submission, possibly using a GUI form, such as that seen in FIG. 8. In some embodiments, the mentor may provide personalized written clarifying feedback via one or more additional GUI forms. In some embodiments, data store 110 may include one or more rubrics or other instructions, which may be accessible to the mentor via the mentor dashboard, which the mentor may access and review in providing feedback to the mentee, in order to provide rubric-based feedback, specifically around the mentee's application of the learned skills. The non-limiting example seen in FIG. 8 demonstrates a rubric based on whether the mentee's work shows no evidence of skills, skills being developed, skills as intermediately competent, and advanced skills. In some embodiments, if the mentor feels that the mentee's work does not show sufficient mastery of skills according to the rubric or instructions to be certified or otherwise validated, they may require the mentee to re-work and resubmit their work, and the process above may be repeated once the mentee re-submits their work.

As seen in FIG. 9, once the mentee learner user has completed the “try it” section, they may move on to the “use it” section, where they apply the foundational and theoretical learning from the “learn it” section, and the hypothetical scenario from the “try it” section to real world scenarios. As seen in FIG. 9, this phase may comprise several steps, including identifying a “live task” comprising of an finding an opportunity to apply the mentee learner's knowledge and practice in a real world scenario (e.g., recognizing a task at work or in a volunteer situation), planning and preparing the opportunity for the live task (including generating an action plan to be approved by the mentor), completing the live task, submitting the live task to the mentor, and “telling their story” by preparing materials to be shared in interviews, on social media (e.g., LinkedIn), etc.

The learner mentee user may identify a live task that they want to complete, such as a work or volunteer opportunity. Using their theoretical and foundational knowledge, as well as the feedback from the “try it” phase, the user may then prepare an action plan for the application of these principles within the context of their live task. This action plan may include an outline and/or step-by-step description of how they are going to prepare and execute the live task. In some embodiments, the system may provide a “tips and tricks” section for preparing the outline for the live task, possibly authored by subject matter experts describing key things that the mentee needs to accomplish in order to do the tasks successfully. The user interface for the use it section may include space for the mentee to plan their goals and to highlight elements they want to work through with a mentor.

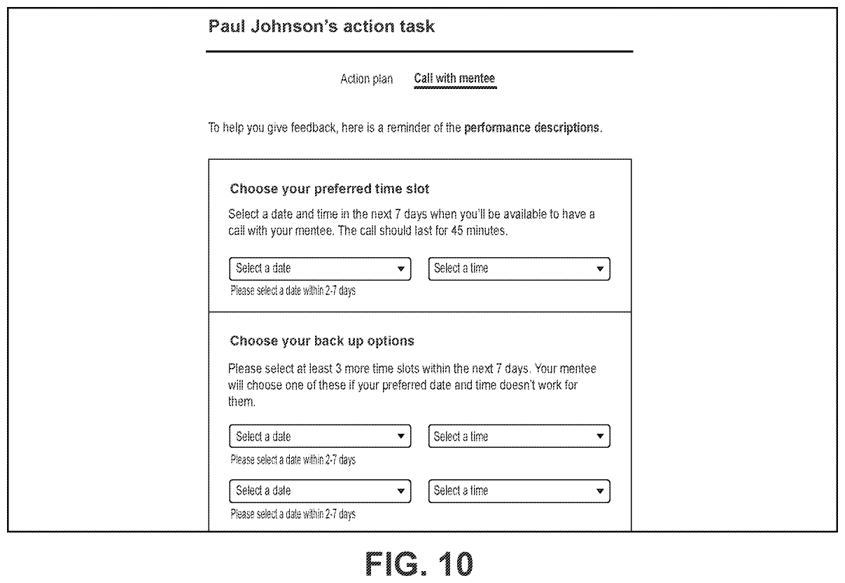

As seen in FIG. 10, once the mentee's action plan is complete and submitted to the mentor, the disclosed system may update the mentor dashboard to include a notification that the action plan is complete, that the mentor needs to review the mentee's action plan, and that the mentor needs to schedule a meeting (e.g., phone call, video chat, etc.) with the mentee. The mentor and mentee may use complimentary scheduling dashboards within the mentor and mentee dashboards, respectively, to find an available time for this review. The mentor and mentee may then meet at the scheduled time to review the mentee's action plan. At the conclusion of the meeting, the system may automatically make the meeting as complete.

After the action plan meeting is complete, the mentee may provide a report of the completed “use it” task, possibly by accessing a GUI form on the mentee dashboard, and/or uploading an electronic document to the system. In response, the system may repeat analogous steps described in detail above, namely providing notifications to the mentor, via the mentor dashboard or email, that the report is complete and available, having the mentor review the submission, scheduling a meeting to review, and completing the meeting between the mentor and mentee to review. The mentor may then provide feedback, similar to that described above.

If the mentee has successfully completed the task according to the instructions and rubric provided to the mentor (i.e., has completed all requirements for the course), the mentor may then certify the mentee, marking their course as complete, possibly via the mentor dashboard.

As demonstrated in FIG. 11, once the course has been marked complete, the mentee's dashboard may be updated into a format to include access to resources from the course that the mentee may use to tell their story in the context of a job search, a cover letter, a job interview, etc. For example, in FIG. 11, the user may access certification (e.g., a downloadable certificate) for the course, mentor feedback, and a list of skills learned through the course.

In some embodiments, a learner mentee user is marketed to directly, possibly after completing their education. However, in some embodiments, an analogous model may be applied to employees that wish to upskill their employees or direct reports. As a non-limiting example, in these embodiments, a manager may act as the mentor, and the manager's direct reports may be the mentees, to which the manager provides the mentor feedback. In these embodiments, the manager may select courses for their direct reports, and follow the flow described above.

In some embodiments, the disclosed system may be configured to automatically check for progression by the mentor and mentee. As non-limiting examples, if a mentee is not progressing through the learn it phase by completing assignments or assessments, the system may generate a notification, after a specific period of time, to provide prompts to the mentee to complete the assignment or assessment. Similar prompts may be provided, via email or dashboard notifications as non-limiting examples, if the mentor has not responded to a mentee's upload of a project action plan or final submission, or if there is no activity from the mentee (e.g., uploading an action plan, providing the final submission, etc.).

In some embodiments, if a mentor is unable to complete a course with a mentee, the system may have access to a pool of additional mentors, possibly paid. In these embodiments, if the original mentor is unavailable, the disclosed system may execute the mentor selection steps described above to identify a closest matching mentor for the mentee, the mentee's selected course, the mentee's relative geography, and the mentor's history, as described in detail above.

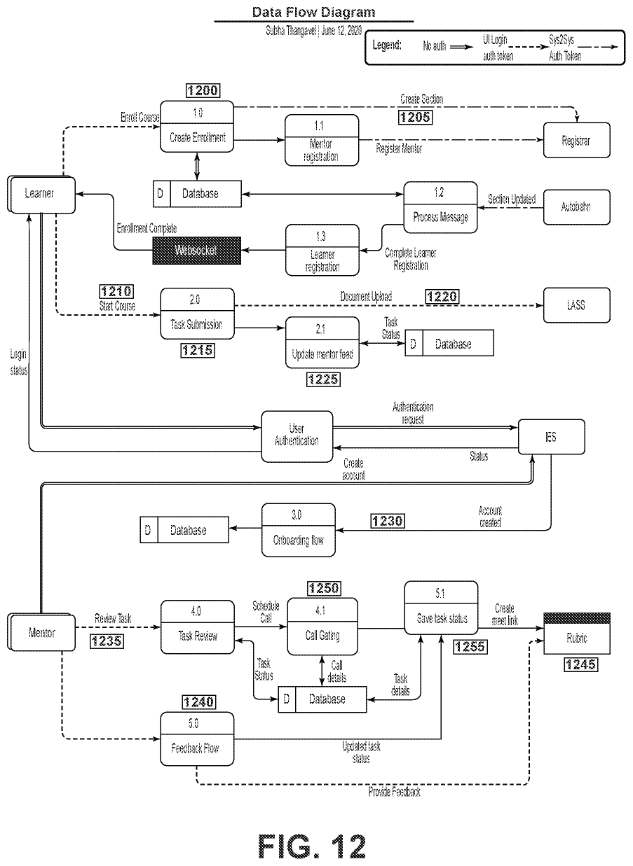

FIG. 12 is a flow diagram demonstrating many of the steps disclosed above. For example, step 1200 demonstrates a mentee learner user registering with the disclosed system and enrolling in a course. Step 1205 demonstrates a registration of a mentor, according to the descriptions above and the subsequent steps explored below. Step 1210 demonstrates a mentee starting the course, and step 1215 demonstrates a mentee's submission of a task (e.g., a submission from the “try it” or “use it” phases described above). Step 1220 demonstrates the upload of a document associated with the task submission, and step 1225 demonstrates an update to the mentor's feed once the task is submitted and the document uploaded. Step 1230 demonstrates the onboarding flow as an account is created for a mentor. Once such an account is created, in step 1235, the mentor reviews the received task submission. In step 1240, the mentor may provide feedback to the mentee, after consulting the associated rubrics in step 1245. The mentor may also consult these rubrics as they schedule and execute a call in step 1250. In step 1255, the results of the mentor feedback and the call may be saved in association with a task status.

Other embodiments and uses of the above inventions will be apparent to those having ordinary skill in the art upon consideration of the specification and practice of the invention disclosed herein. The specification and examples given should be considered exemplary only, and it is contemplated that the appended claims will cover any other such embodiments or modifications as fall within the true scope of the invention.

The Abstract accompanying this specification is provided to enable the United States Patent and Trademark Office and the public generally to determine quickly from a cursory inspection the nature and gist of the technical disclosure and in no way intended for defining, determining, or limiting the present invention or any of its embodiments.

The invention claimed is:

1. A system comprising:
a database coupled to a network and storing a plurality of user metadata defining a set of initial skills of a user;
a server comprising a computing device coupled to the network and comprising a processor executing instructions within a memory which, when executed, cause the system to:
receive a user metadata in the plurality of user metadata defining a set of initial skills of a user;
receive a user goal that includes a set of requisite skills;
compare the set of initial skills to the set of requisite skills identify a set of untrained skills that are included in the set of requisite skills and that are not included in the set of initial skills;
generate a skill path based on the set of untrained skills, the skill path defining an ordered sequence of untrained skills of the set of untrained skills and corresponding courses;
delivering, by the processor, course content to a user device associated with the user, the course content being associated with a first course of the corresponding courses and a first skill of the untrained skills;
determine that the user has progressed to the end of the course;
upon determining that the user has progressed to the end of the course, deliver a summative assessment to the user via the user device;
receive responses from the user device in response to the summative assessment;
analyze the responses to determine a summative assessment grade;
determine that the user has successfully completed the first course by determining that the summative assessment grade exceeds a predetermined threshold;
issue a credential to the user upon determining that the user has successfully completed the first course;
send a notification to an authorized third party server indicating that the user has successfully completed the first course;
sequentially deliver additional course content and additional summative assessments to the user via the user device until the user has successfully completed each of the corresponding courses; and
send a notification to the user device indicating that the user has successfully completed each of the corresponding courses.

2. The system of claim 1, wherein the instructions, when executed, further cause the system to:
receive a set of mentor metadata for a plurality of mentors included in a mentor pool;
compare, for each mentor of the plurality of mentors, associated mentor metadata of the set of mentor metadata to the user metadata to generate a plurality of similarity scores;
identify a mentor of the plurality of mentors having first characteristics that are similar to second characteristics of the user based on the similarity scores;
assign the mentor to the user;
send a first notification to the user device indicating that the mentor has been assigned to the user; and
send a second notification to a mentor device of the mentor indicating that the mentor has been assigned to the user.

3. The system of claim 2, wherein the instructions, when executed, further cause the system to:
identify, within the mentor metadata and the user metadata:
a course characteristic associated with both the mentor and the user;
a geography characteristic associated with both the mentor and the user;
generate the similarity score according to a course characteristic common to the mentor metadata and the user metadata; and
assign the mentor to the user.

4. The system of claim 2, wherein the instructions, when executed, further cause the system to:
identify within the mentor metadata and the user metadata:
the first characteristics associated with the user metadata; and
the second characteristics associated with the mentor metadata;
generate:
a first feature vector from a first multidimensional array generated from the first characteristics; and
a second feature vector from a second multidimensional array generated from the second characteristics; and
plot the first feature vector and the second feature vector; and
identify the characteristics that are similar by identifying a smallest distance between the first feature vector and the second feature vector.

5. The system of claim 2, wherein the instructions, when executed, further cause the system to organize, within the course:
a first learning phase, wherein the course content comprises a theory, a plurality of foundational principles, and the skill path for the course;
a second learning phase comprising an application of the theory, the plurality of foundational principles, and the skill path to a hypothetical scenario; and
a third learning phase comprising an application of the theory, the plurality of foundational principles, and the skill path to a live business or volunteer situation.

6. The system of claim 5, wherein the instructions, when executed, further cause the system to:
generate a user dashboard configured to:
receive, from the user, input comprising:
a summary of the second learning phase or the third learning phase;
a self-assessment of the user in the first learning phase or the second learning phase; and
a request for a meeting with the mentor to review the first phase or the second phase;
generate a mentor dashboard configured to:
receive, from the mentor, input comprising:
a feedback of a user performance for the second learning phase or the third learning phase; and
an acceptance for the request for a meeting;
store the summary, the self-assessment, and the feedback; and
facilitate the meeting via one or more video conferencing software modules.

7. A method comprising:
receiving, by a processor, user metadata defining a set of initial skills of a user;
receiving, by the processor, a user goal that includes a set of requisite skills;
comparing, by the processor, the set of initial skills to the set of requisite skills identify a set of untrained skills that are included in the set of requisite skills and that are not included in the set of initial skills;
generating, by the processor, a skill path based on the set of untrained skills, the skill path defining an ordered sequence of untrained skills of the set of untrained skills and corresponding courses;
delivering, by the processor, course content to a user device associated with the user, the course content being associated with a first course of the corresponding courses and a first skill of the untrained skills;
determining, by the processor, that the user has progressed to the end of the course;
upon determining that the user has progressed to the end of the course, delivering, by the processor, a summative assessment to the user via the user device;
receiving, by the processor, responses from the user device in response to the summative assessment;
analyzing, by the processor, the responses to determine a summative assessment grade;
determining, by the processor, that the user has successfully completed the first course by determining that the summative assessment grade exceeds a predetermined threshold;
issuing, by the processor, a credential to the user upon determining that the user has successfully completed the first course;
sending, by the processor, a notification to an authorized third party server indicating that the user has successfully completed the first course;
sequentially delivering, by the processor, additional course content and additional summative assessments to the user via the user device until the user has successfully completed each of the corresponding courses; and
sending, by the processor, a notification to the user device indicating that the user has successfully completed each of the corresponding courses.

8. The method of claim 7, further comprising:
receiving, by the processor, a set of mentor metadata for a plurality of mentors included in a mentor pool;
comparing, by the processor for each mentor of the plurality of mentors, associated mentor metadata of the set of mentor metadata to the user metadata to generate a plurality of similarity scores;
identifying, by the processor, a mentor of the plurality of mentors having first characteristics that are similar to second characteristics of the user based on the similarity scores;
assigning, by the processor, the mentor to the user;
sending, by the processor, a first notification to the user device indicating that the mentor has been assigned to the user; and
sending, by the processor, a second notification to a mentor device of the mentor indicating that the mentor has been assigned to the user.

9. The method of claim 8, further comprising:
identifying, by the processor, within the mentor metadata and the user metadata:
a course characteristic associated with both the mentor and the user;
a geography characteristic associated with both the mentor and the user;
generating, by the processor, the similarity score according to a course characteristic common to the mentor metadata and the user metadata; and
assigning, by the processor, the mentor to the user.

10. The method of claim 8, further comprising:
identifying, by the processor, within the mentor metadata and the user metadata:
the first characteristics associated with the user metadata; and
the second characteristics associated with the mentor metadata;
generating, by the processor:
a first feature vector from a first multidimensional array generated from the first characteristics; and
a second feature vector from a second multidimensional array generated from the second characteristics; and
plotting, by the processor, the first feature vector and the second feature vector; and
identifying, by the processor, the characteristics that are similar by identifying a smallest distance between the first feature vector and the second feature vector.

11. The method of claim 8, further comprising organizing, by the processor, within the course:
a first learning phase, wherein the course content comprises a theory, a plurality of foundational principles, and the skill path for the course;
a second learning phase comprising an application of the theory, the plurality of foundational principles, and the skill path to a hypothetical scenario; and
a third learning phase comprising an application of the theory, the plurality of foundational principles, and the skill path to a live business or volunteer situation.

12. The method of claim 11, further comprising:
generating, by the processor, a user dashboard configured to:
receive, from the user, input comprising:
a summary of the second learning phase or the third learning phase;
a self-assessment of the user in the first learning phase or the second learning phase; and
a request for a meeting with the mentor to review the first phase or the second phase;
generating, by the processor, a mentor dashboard configured to:
receive, from the mentor, input comprising:
a feedback of a user performance for the second learning phase or the third learning phase; and
an acceptance for the request for a meeting;
storing, by the processor, the summary, the self-assessment, and the feedback; and
facilitating the meeting via one or more video conferencing software modules.

13. A system comprising a server comprising a computing device coupled to the network and comprising a processor executing instructions within a memory, wherein the server is configured to:
receive a user metadata in the plurality of user metadata defining a set of initial skills of a user;
receive a user goal that includes a set of requisite skills;
compare the set of initial skills to the set of requisite skills identify a set of untrained skills that are included in the set of requisite skills and that are not included in the set of initial skills;
generate a skill path based on the set of untrained skills, the skill path defining an ordered sequence of untrained skills of the set of untrained skills and corresponding courses;
delivering, by the processor, course content to a user device associated with the user, the course content being associated with a first course of the corresponding courses and a first skill of the untrained skills;
determine that the user has progressed to the end of the course;
upon determining that the user has progressed to the end of the course, deliver a summative assessment to the user via the user device;
receive responses from the user device in response to the summative assessment;
analyze the responses to determine a summative assessment grade;
determine that the user has successfully completed the first course by determining that the summative assessment grade exceeds a predetermined threshold;
issue a credential to the user upon determining that the user has successfully completed the first course;
send a notification to an authorized third party server indicating that the user has successfully completed the first course;
sequentially deliver additional course content and additional summative assessments to the user via the user device until the user has successfully completed each of the corresponding courses; and
send a notification to the user device indicating that the user has successfully completed each of the corresponding courses.

14. The system of claim 13, wherein the server is further configured to:
receive a set of mentor metadata for a plurality of mentors included in a mentor pool;
compare, for each mentor of the plurality of mentors, associated mentor metadata of the set of mentor metadata to the user metadata to generate a plurality of similarity scores;
identify a mentor of the plurality of mentors having first characteristics that are similar to second characteristics of the user based on the similarity scores;
assign the mentor to the user;
send a first notification to the user device indicating that the mentor has been assigned to the user; and
send a second notification to a mentor device of the mentor indicating that the mentor has been assigned to the user.

15. The system of claim 14, wherein the server is further configured to:
identify, within the mentor metadata and the user metadata:
a course characteristic associated with both the mentor and the user;
a geography characteristic associated with both the mentor and the user;
generate the similarity score according to a course characteristic common to the mentor metadata and the user metadata; and
assign the mentor to the user.

16. The system of claim 14, wherein the server is further configured to:
identify within the mentor metadata and the user metadata:
the first characteristics associated with the user metadata; and
the second characteristics associated with the mentor metadata;
generate:
a first feature vector from a first multidimensional array generated from the first characteristics; and
a second feature vector from a second multidimensional array generated from the second characteristics; and
plot the first feature vector and the second feature vector; and
identify the characteristics that are similar by identifying a smallest distance between the first feature vector and the second feature vector.

17. The system of claim 14, wherein the server is further configured to organize, within the course:
a first learning phase, wherein the course content comprises a theory, a plurality of foundational principles, and the skill path for the course;
a second learning phase comprising an application of the theory, the plurality of foundational principles, and the skill path to a hypothetical scenario; and
a third learning phase comprising an application of the theory, the plurality of foundational principles, and the skill path to a live business or volunteer situation.

18. The system of claim 17, wherein the server is further configured to:
generate a user dashboard configured to:
receive, from the user, input comprising:
a summary of the second learning phase or the third learning phase;
a self-assessment of the user in the first learning phase or the second learning phase; and
a request for a meeting with the mentor to review the first phase or the second phase;
generate a mentor dashboard configured to:
receive, from the mentor, input comprising:
a feedback of a user performance for the second learning phase or the third learning phase; and
an acceptance for the request for a meeting;
store the summary, the self-assessment, and the feedback; and
facilitate the meeting via one or more video conferencing software modules.
